(19) United States
(12) Patent Application Publication
(10) Pub. No.: US 2023/0101976 A1
(43) Pub. Date: Mar. 30, 2023

(54) Steering System with Protective Bellows and Rolling Diaphragms

(71) Applicant: Robert Bosch Automotive Steering LLC, Florence, KY (US)

(72) Inventor: Scott R. Kloess, Rochester Hills, MI (US)

(21) Appl. No.: 17/944,027

(22) Filed: Sep. 13, 2022

Related U.S. Application Data
(60) Provisional application No. 63/250,457, filed on Sep. 30, 2021.

(51) Int. Cl. F16J 3/04; B62D 7/16

(52) U.S. Cl. CPC F16J 3/042; B62D 7/163

(57) ABSTRACT

Disclosed is a steering system comprising a housing, a steering rack which is movably arranged and extends out, of a housing end section of the housing on at least one side of the housing with a steering rack end portion, at least one tie rod attached to the steering rack with a ball joint, at least one bellows covering the steering rack end portion of the steering rack, the ball joint and a section of the tie rod adjacent to the ball joint, the bellows having a first end and a second end, the first end being attached to the housing end section and the second end being attached to the tie rod at a tie rod attachment section, wherein a rolling diaphragm is arranged inside of the bellows, wherein a first end of the rolling diaphragm is attached to the housing end section and a second end of the rolling diaphragm is attached to the ball joint or the steering rack end portion, and wherein a rolling bend of the rolling diaphragm is movable between the housing and the second end of the bellows.

### TECHNICAL FIELD

The present invention relates to vehicle steering systems with protective bellows and rolling diaphragms.

### BACKGROUND

Steering systems have steering racks ends that extend out of a housing and are connected to tie rods via ball joints. Protective bellows are used to cover and protect these connections. Particularly in harsher environments there is an increased risk of punctures by sticks or rocks that get thrown up. This allows water and contaminants to enter the steering system. Punctured bellows might require the steering system to eventually be replaced if not repaired in time.

### SUMMARY

One aspect of this disclosure is directed to a steering system comprising a housing, a steering rack which is movably arranged and extends out of a housing end section of the housing on at least one side of the housing with a steering rack end portion, at least one tie rod attached to the steering rack end portion with a ball joint, at least one bellows covering the steering rack end portion, the ball joint and a section of the tie rod adjacent to the ball joint, the bellows haying, a first end and a second end, the first end being attached to the housing end section and the second end being attached to the tie rod at a tie rod attachment section, wherein a rolling diaphragm is arranged inside of the bellows, wherein a first end of the rolling diaphragm is attached to the housing end section and a second end of the rolling diaphragm is attached to at least one of the ball joint and steering rack end portion, and wherein a rolling bend of the rolling diaphragm is movable between the housing and the second end of the bellows. This may provide a second or redundant seal in addition to the bellows. Because of the rolling bend folds or rolls on itself it does not negatively interfere with the bellows. Since the rolling diaphragm is mounted on the ball joint of the steering rack—or inner tie rod—this defines a mid or nominal point in the neutral steering position and allows it to go to full extension travel and minimum travel compression point. Mounting it there also minimizes the impact of the articulation to which the tie rod is subjected. At the fully extended position of the steering rack end there may still be at least a slight roll beyond the second end of the rolling diaphragm.

In some embodiments, the rolling diaphragm has radial and axial dimensions within the bellows so as to not interfere beyond a predetermined range with each other when the steering rack end portion moves between a fully retracted position and a fully extended position and the tie rod pivots on the ball joint during at least one of the group comprising steering movements of the steering rack and up-and-down movements of a suspension.

In some embodiments, the second end of the bellows is located at a distance from the housing which is not smaller than the distance of the rolling bend from the housing when the ball joint is the closest to the housing.

In some embodiments, the housing defines a stop for the ball joint, wherein the steering rack has a position in which the ball joint is the closest to the stop, in which position the rolling bend is the closest to the stop and in which position the tie rod attachment section is at least as far away from the stop as the rolling bend or is further away from the stop than the rolling bend.

In some embodiments, the steering rack has a neutral position away from the position in which the ball joint is the closest to the stop and in in which the tie rod attachment section moves twice as much away from the housing as the rolling bend.

In some embodiments, wherein at least an inner bend of at least a fold of the bellows closest to the second end of the bellows has an inner diameter that is at least as big as an outer diameter of the rolling bend.

In some embodiments, a second end of the rolling diaphragm is attached to the outer circumference of the ball joint.

In some embodiments, a first end of the rolling diaphragm is attached to an inner circumference of the housing end section.

In some embodiments, the rolling bend of the diaphragm is arranged outside of the housing end section.

The above aspects of this disclosure and other aspects will be explained in greater detail below with reference to the attached drawings.

### BRIEF DESCRIPTION OF THE DRAWINGS

FIG. 1 depicts a longitudinal section of parts of a steering rack assembly according to the invention in a hilly retracted position of one steering rack end portion of the steering rack.

FIG. 2 depicts one side of the steering rack assembly of FIG. 1 in a neutral position of the steering rack.

FIG. 3 the steering rack assembly of FIG. 1 in a fully extended position of the steering rack end portion.

FIG. 4 depicts a longitudinal section of a known steering rack assembly.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

FIG. 4 depicts a partial longitudinal section of a power steering system or steering rack assembly 10. The steering system 10 may be a power steering system or a manual steering system. Other possible applications instead of the depicted steering system 10 may be a manual gear, a single or dual pinion gear, a belt drive gear, hydraulic power steering system gear, a rear steer gear, and a single wheel road actuator. The steering rack assembly 10 includes a pinion 12 and a steering rack 14. The pinion 12 is in engagement with teeth 15 of a toothed member 16 of the steering rack 14. The steering rack 14 has the shape of a hollow tube. But solid and/or different cross sections may be used as well. The steering rack 14 is mounted in a tubular housing 18. The housing may also be non-tubular. Ball joints 20 are attached on each axial end of the steering rack 14. Each ball joint 20 is connected to a tie rod 22 of which only one is shown. The steering rack 14 may be supported by two bearings 24 that are located inside the housing 18. If the steering system is an electrical power steering (EPS) or a power steering with an axially parallel layout (APA) or a manual gear only one bearing such as a yoke shoe 25 which is also depicted in FIG. 4 may be arranged on the pinion side. In the case of a manual gear the other side may have a bearing. The housing 18 has end sections 26 that extend beyond the bearings 24. The steering rack 14 is movably arranged and extends out of the housing 18 on both sides but should extend at least on one side of the housing 18. The steering rack 14 and housing 18 define a longitudinal or central axis 28 along which the steering rack 14 travels in operation. The tie rod 22 is shown in a straight line with the central axis 28. But, depending on the configuration or application, the tie rod 22 may be arranged at an angle to the central axis 28.

The sections of the steering rack 14 extending outside of the housing 18, the ball joints 20 and the part of the tie rods 22 adjacent to the ball joints 20 are covered by protective bellows 30. The bellows 30 in automotive applications are also called gaiters or boots. Alternatively, if the ball joints 20 are sufficiently sealed, the bellows 30 may be attached to the ball joints 20 and not on the adjacent part of the tie rods 22. The bellows 30 cover therefore at least the steering rack 14 extending outside of the housing 18 and the ball joints 20 or in addition sections of the tie rods 22. The bellows 30 also define the central axis 28. It shall be noted that the central axis 28 may be angled at the ball joint 20 due to the suspension of a vehicle moving up and down and/or the wheels of a vehicle being turned. The bellows 30 further comprise a first end 32 defining a first opening around the central axis 28 and a second end 34 defining a second opening around the central axis 28. The first ends 32 are connected to the outside of the end sections 26 of the housing 18 for example with a crimp connection or other attachment method. Clamps may be used, too. The second ends 34 are connected to the tie rods 22. The area of the bellows 30 adjacent to the second ends 34 are not shown as a longitudinal sectional view.

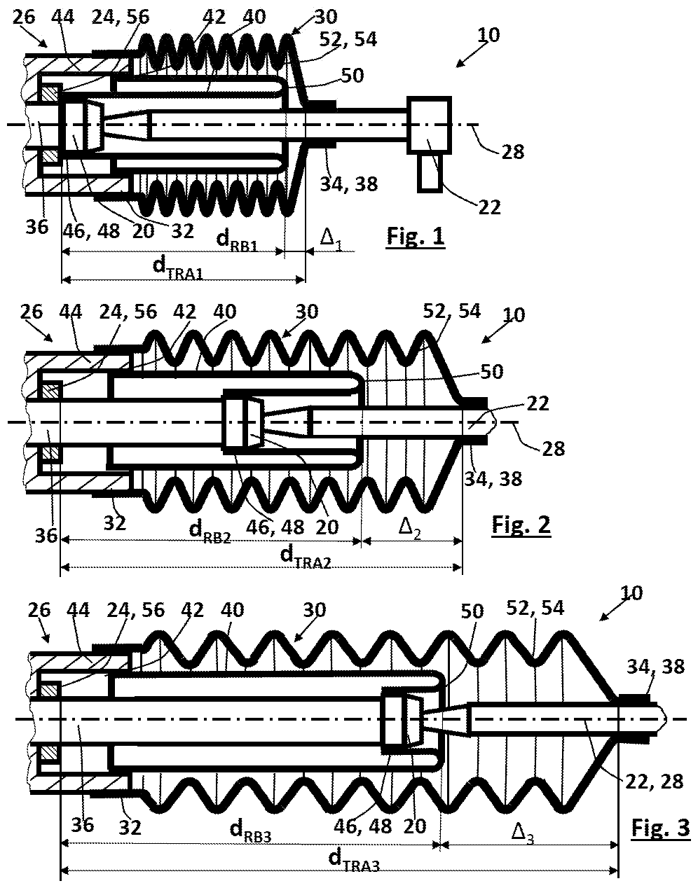

FIGS. 1, 2 and 3 depict a simplified representation of the right area of the steering system 10 of FIG. 4 modified according to the present invention. Only the parts of the right area are described. But it is to be understood that these may apply to both sides of steering system 10. As mentioned above, the steering system 10 comprises a housing 18 and a steering rack 14. The steering rack 14 is movably arranged in the housing 18 and extends out of a tubular housing end section 26 on either side of the housing 18 with steering rack end portions 36. The steering system 10 further comprises two tie rods 22 attached to the steering rack end portions 36 with ball joints 20. A bellows 30 covers a steering rack end portion 36 of the steering rack 14. The ball joint 20 and a section of the tie rod 22 adjacent to the ball joint 20. The bellows 30 has a first end 32 and a second end 34. The first end 32 is attached to the housing end section 26 and the second end 34 is attached to the tie rod 22 at a tie rod attachment section 38.

A rolling diaphragm 40 or rolling diaphragm seal is arranged inside of the bellows 30. A first end 42 of the rolling diaphragm 40 is attached to the housing end section 26. The first end 42 of the rolling diaphragm 40 may be attached to an inner circumference 44 of the housing end section 26. It may be attached to an outer circumference, too. A second end 46 of the rolling diaphragm 40 may be attached to the ball joint 20. In particular, the second end 46 of the rolling diaphragm 40 may be attached to the outer circumference 48 of the ball joint 20. It is also possible that the second end 46 of the rolling diaphragm 40 is attached to the steering rack 14, in particular the steering rack end portion 36, instead of the ball joint 20, or the steering rack end portions 36, and a disc between the steering rack 14 and an inner side of the ball joint 20. The rolling diaphragm 40 may be directly attached to the steeling rack 14 or indirectly with an intermediate attachment piece such as a washer plate (not shown) between the steering. rack 14 and inner tie rod end. This would allow an easier build during the manufacturing process. It would also allow for the inner tie rod ends to be removed for service without unclamping the diaphragm. The first and second ends 42, 46 may be attached with a clamp and/or by gluing.

A rolling bend 50 of the rolling diaphragm 40 is movable between the housing 18 and the second end 34 of the bellows 30. The part of the rolling diaphragm which constitutes the rolling bend 50 changes depending on the axial extension of the first end 42 and second end 46. The rolling bend 50 defines an arc of approximately 180°. It may be designated as a rolling convolution. The rolling bend 50 of the rolling diaphragm 40 may be arranged outside of the housing end section 26 as depicted in FIGS. 1, 2 and 3. However, if the housing end sections 26 are longer than shown the rolling bend 50 may he inside the end sections 26 depending on how far the steering rack end portions 36 protrude from the housing end sections 26.

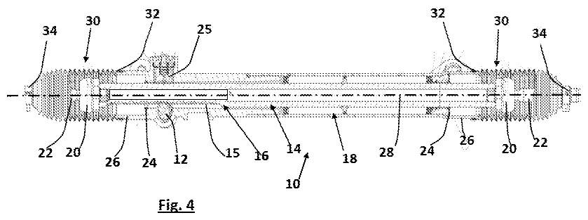

The rolling diaphragm 40 has radial and axial dimensions within the bellows 30 so that the bellows 30 and the rolling diaphragm 40 do not normally interfere with each other beyond a predetermined range when the steering rack end portion 36 moves between a fully retracted position (FIG. 1), the neutral position (FIG. 2) and a fully extended position (FIG. 3) and the tie rod 22 pivots on the ball joint 20 during steering movements of the steering rack and/or up-and-down movements of a suspension. Alternatively, the rolling diaphragm 40 may be dimensioned to have a radial and axial clearance within the bellows 30 so it does interfere beyond a predetermined range with the bellows 30 or does not touch the bellows 30 when the steering rack 14 moves. A predetermined range may be when the rolling diaphragm 40 does not touch or hardly touches the inner surface of the bellows 30. That might be advisable if the rolling diaphragm 40, besides having flexible properties, is not very elastic. Depending on the elastic or flexible properties of the rolling diaphragm 40 and the bellows 30, they may also push and/or bend each other, in particular when the steering rack end portion 36 approaches its fully retraced position. It is to be understood that the rolling diaphragm 40 and the bellows 30 may touch each other as long as they do not hinder each other's performance. For a clearance, as shown in FIG. 1, at least an inner bend 52 of at least a fold 54 of the bellows 30 closest to the second end 34 of the bellows 30 may have an inner diameter that is at least as big as an outer diameter of the rolling bend 50. This prevents that areas of the bellows 30 adjacent to the second end 34 push on the rolling diaphragm 40 in the filly retracted position. The rolling diaphragm 40 may be flexible and can be made out of a tough rubber and fiber material which would survive some level of allowing the rolling diaphragm 40 to contact the inner bellows surface or the inner housing surface.

The second end 34 of the bellows 30 may be located at a distance from the housing 18 which is not smaller than the distance of the rolling bend 50 from the housing 18 when the ball joint 20 is the closest to the housing 18 or, as shown in FIG. 1, inside housing end section 26.

The housing 18 defines a stop 56 for the ball joint 20. The stop 56 coincides with the axial outside of the bearing 24. The steering rack 14 has a position in which the ball joint 20 is the closest to the stop 56. In this position, the rolling bend 50 is the closest to the stop 56 and in this position the tie rod attachment section 38 is at least as far away from the stop 56 as the rolling bend 50 or, as shown in FIG. 1, is further away from the stop than the rolling bend 50.

The steering rack 14 has a neutral position, as shown in FIG. 2, in which the ball joint 20 is further away from the position in which the ball joint 20 is the closest to the stop. To arrive at this position, the second end 34 of the bellows 30 (as well as the tie rod attachment section 38) moved twice as much away from the housing 18 as the rolling bend 50.

As mentioned above, the housing 18 has a stop 56 for the ball joint 20 inside of the housing end section 26. The rolling bend 50 has a first rolling bend distance d_{RB1} to the stop 56 and the tie rod attachment section 38 has a first tie rod attachment section distance d_{TRA1} to the stop 56 when the steering rack end portion 36 is in a fully retracted position. The rolling bend 50 has a second rolling bend distance d_{RB2} to the stop and the tie rod attachment section has a second tie rod attachment section distance d_{TRA2} to the stop 56 when the steering rack end portion 36 is in a neutral position. The rolling bend 50 has a third rolling bend distance d_{RB3} to the stop and the tie rod attachment section 38 has a third tie rod attachment section distance d_{TRA3} to the stop 56 when the steering rack end portion 36 is in a fully extended position. The first tie rod attachment distance d_{TRA1} subtracted by the first rolling bend 50 distance der results in a first difference Δ₁. The second tie rod attachment distance d_{TRA2} subtracted by the second rolling bend 50 distance d_{RB2} results in a second difference Δ₂. The third tie rod attachment distance d_{TRA3} subtracted by the third rolling bend 50 distance d_{RB3} results in a third difference Δ₃. The third difference Δ₃ normally twice as big as the second difference Δ₂. The second difference Δ₂ is bigger than the absolute value of the first difference Δ₁. The above relations may be described with the following formulas: d_{TRA1}−d_{RB1}=Δ₁, d_{TRA2}−d_{RB2}=Δ₂, d_{TRA3}−d_{RB3}=Δ₃, Δ₃=>2*Δ₂Δ₂>|Δ₁|. The value of the first difference Δ₁ may be less than zero for example in case there is an axial bulge in the flank extending from the second end 34 of the bellows 30 that is axially extending away towards the tip of the tie rod which could accommodate the rolling bend 50.

It is understood that the foregoing detailed description and accompanying examples are merely illustrative and are not to be taken as limitations upon the scope of the invention, which is defined solely by the following claims. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use of the invention, may be made without departing from the spirit and scope thereof.

What is claimed is:

1. Steering system comprising
a housing,
a steering rack which is movably arranged and extends out of a housing end section of the housing on at least one side of the housing with a steering rack end portion,
at least one tie rod attached to the steering rack end portion with a ball joint,
at least one bellows covering at least partially covering the steering rack end portion, the ball joint and a section of the tie rod adjacent to the ball joint, the bellows having a first end and a second end, the first end being attached to the housing end section and the second end being attached to the tie rod at a tie rod attachment section,
wherein a rolling diaphragm is arranged inside of the bellows,
wherein a first end of the rolling diaphragm is attached to the housing end section and a second end of the rolling diaphragm is attached to at least one of the ball joint and steering rack end portion,
and wherein a rolling bend of the rolling diaphragm is movable between the housing and the second end of the bellows.

2. Steering system according to claim 1, wherein the rolling diaphragm has radial and axial dimensions within the bellows so as to not interfere beyond a predetermined range with each other when the steering rack end portion moves between a fully retracted position and a fully extended position and the tie rod pivots on the ball joint during at least one of the group comprising steering movements of the steering rack and up-and-down movements of a suspension.

3. Steering system according to claim 1, wherein the second end of the bellows is located at a distance from the housing which is not smaller than the distance of the rolling bend from the housing when the ball joint is the closest to the housing.

4. Steering system according to claim 1, wherein the housing defines a stop for the ball joint, wherein the steering rack has a position in which the ball joint is the closest to the stop, in which position the rolling bend is the closest to the stop and in which position the tie rod attachment section is at least as far away from the stop as the rolling bend or is further away from the stop than the rolling bend.

5. Steering system according to claim 1, wherein the steering rack has a neutral position away from the position in which the ball joint is the closest to the stop and in in which the tie rod attachment section moves twice as much away from the housing as the rolling bend.

6. Steering system according to claim 1, wherein at least an inner bend of at least a fold of the bellows closest to the second end of the bellows has an inner diameter that is at least as big as an outer diameter of the rolling bend.

7. Steering system according to claim 1, wherein the housing has a stop for the ball joint inside of the housing end section,
wherein the rolling bend has a first rolling bend distance d_{RB1} to the stop and the tie rod attachment section has a first tie rod attachment section distance d_{TRA1} to the stop when the steering rack end portion is in a fully retracted position,
wherein the rolling bend has a second rolling bend distance d_{RB2} to the stop and the tie rod attachment section has a second tie rod attachment section distance d_{TRA2} to the stop when the steering rack end portion is in a neutral position,
wherein the rolling bend has a third rolling bend distance d_{RB3} to the stop and the tie rod attachment section has a third tie rod attachment section distance d_{TRA3} to the stop when the steering rack end portion is in a fully extended position,
wherein the first tie rod attachment distance d_{TRA1} subtracted by the first rolling bend distance d_{RB1} results in a first difference Δ₁,
wherein the second tie rod attachment distance d_{TRA2} subtracted by the second rolling bend distance d_{RB2} results in a second difference Δ₂,
wherein the third tie rod attachment distance d_{TRA3} subtracted by the third rolling bend distance d_{RB3} results in a third difference Δ₃, and
wherein the third difference Δ₃ is twice as big as the second difference Δ₂ and the second difference Δ₂ is bigger than the absolute value of the first difference Δ₁.

8. Steering system according to claim 1, wherein a second end of the rolling diaphragm is attached to one of the outer circumference of the ball joint, the steering rack end portions, and a disc between the steering rack and an inner side of the ball joint.

9. Steering system according to claim 1, wherein a first end of the rolling diaphragm is attached to one of an inner circumference and an outer circumference of the housing end section.

10. Steering system according to claim 1, wherein the rolling bend of the diaphragm is arranged outside of the housing end section.
